(19) United States
(12) Patent Application Publication
(10) Pub. No.: US 2006/0237993 A1
(43) Pub. Date: Oct. 26, 2006

(54) Reinforcement device for trailer walls

(76) Inventor: Allan J. Wiebe, Winkler (CA)

Correspondence Address: Ryan W. Dupuis;Ade & Company, 1700-360 Main Street, Winnipeg, MB, R3C 3Z3, CA

(21) Appl. No.: 11/114,045

(22) Filed: Apr. 26, 2005

(51) Int. Cl. B62D 25/02

(52) U.S. Cl. 296/186.1

(57) ABSTRACT

A reinforcement device comprises a rigid post with hook members at spaced positions therein for selectively mounting the rigid post alongside mounting posts within a conventional trailer. The hook members permit the reinforcement device to be selectively removed so that the rigid posts can be used when loose cargo, which imposes lateral forces on the sidewalls, is carried to resist bending of the sidewalls while permitting the maximum interior dimension of the trailer to be used when carrying cargo within containers by simply removing the rigid posts.

### FIELD OF THE INVENTION

The present invention relates to a reinforcement device for use on side walls of a trailer, and more particularly relates to a device which resists bending of the walls when a load exerts a laterally outward force on the walls.

### BACKGROUND

It is common to haul cargo using trucks and towed trailers either having a flatbed, with or without stakes along the sides for containing the cargo, or an enclosed trailer. The enclosed trailer typically has a flat floor with side walls extending upwardly from opposing side edges thereof to a roof spanning between the sidewalls spaced above the floor. The sidewalls are constructed so as to have a minimum thickness to both maximize the interior space for receiving cargo and to maintain the overall outer width of the trailer within limits prescribed by road transportation regulations. The resulting walls of typical enclosed trailers are thus not intended to support loads which exert a lateral outward force thereon but are intended instead to receive cargo in boxes or containers which occupy the full interior width of the trailer in standard sizes. When a such an enclosed trailer is loaded with loose cargo items, for instance elongate rolls of carpet stacked parallel to one another and extending in the longitudinal direction of the trailer parallel to the side walls, the load tends to distribute itself and spread out in a manner which causes the side walls to bow outwardly, causing damage to the trailer and exceeding the maximum width of the trailer which is permitted when on the road.

The typical structure of the side walls of enclosed cargo trailers includes a plurality of logistic posts which are vertically oriented parallel to one another at spaced positions in the longitudinal direction of the trailer. The posts each include a plurality of vertically spaced mounting apertures therein for receiving tie down equipment or other types of brackets used to secure cargo. The tie-down devices for attachment to the existing logistic posts generally do not add any strength to the side walls.

Typical attempts to reinforce the side walls of the trailer result in the structure of the walls becoming thicker so that the interior dimension of the trailer is permanently reduced and standard size cargo can no longer be received within the trailer. Alternatively, thickening of the structure of the side walls results in the overall outer dimension of the trailer increasing which is not permissible according to road regulations.

### SUMMARY OF THE INVENTION

According to one aspect of the invention there is provided, in a trailer comprising a floor, side walls extending up from the floor and a roof spanning the side walls in which the side walls include mounting posts having mounting apertures at vertically spaced positions therein, a reinforcement device comprising:

a rigid post having a length which is near a height of the side walls;

and hook members supported on the rigid post for being received in respective ones of the mounting apertures to support the rigid post in an upright orientation alongside one of the side walls.

According to a second aspect of the present invention there is provided a trailer comprising:

a floor;

side walls extending up from the floor;

a roof spanning the side walls spaced upwardly from the floor;

mounting posts having mounting apertures at vertically spaced positions along the wall;

a plurality of reinforcement devices, each comprising:
a rigid post having a length which is near a height of the mounting posts; and
hook members supported on the rigid post and selectively received in respective ones of the mounting apertures such that each rigid post is supported by the hook members in an upright orientation alongside one of the side walls.

According to a further aspect of the present invention there is provided a method of reinforcing a trailer comprising a floor, side walls extending up from the floor and a roof spanning the side walls in which the side walls include mounting posts having mounting apertures at vertically spaced positions therein, the method comprising:

providing a plurality of reinforcement devices, each comprising a rigid post having a length which is near a height of the mounting posts; and hook members supported on the rigid post; and

inserting the hook members of the reinforcement devices into respective mounting apertures of the mounting posts to support the rigid posts in an upright orientation alongside the side walls respectively.

The use of an elongate post having a height which is near a height of the side walls while including hooks for selective attachment to the mounting apertures in the sidewalls is advantageous because the posts can be used only when loose cargo is present. The reinforcement posts can easily be removed by simply releasing the hooks from the mounting apertures to maintain the maximum interior dimension of the trailer needed for standard size cargo to be received subsequently therein. The height of the post being near the height of the side walls ensures that lateral loads are distributed to the ends of the post near the floor and roof of the trailer where bending is less of concern because the sidewalls are maintained at a fixed spacing relative to one another at the top and bottom ends by the floor and roof respectively.

Preferably the hook members are longitudinally spaced from one another within a common plane and each include a hook portion projecting from the rigid post in a common direction to a free end including a camming face thereon.

The hook members may each include a hook portion extending downwardly alongside the rigid post towards a bottom end of the post, in which the hook members are spaced upwardly from the bottom end of the rigid post in the order of 1 foot or more.

The method may include sliding the reinforcement devices downward after inserting the hook members into the respective mounting apertures to displace the hook members from an unlocked position to a locked position.

When the trailer includes base plates spanning a bottom end of the side walls respectively, the method may include overlapping the reinforcement devices over the base plates when inserting the hook members into the respective mounting apertures.

The rigid post may comprises a hollow member of tubular cross-section which resists bending. In further embodiments however, the post may have any suitable cross section which resists bending. Steel, various metal alloys or other high strength composite materials may be used.

One embodiment of the invention will now be described in conjunction with the accompanying drawings in which:

### BRIEF DESCRIPTION OF THE DRAWINGS

FIG. 1 is a perspective view of the reinforcement device.

FIG. 2 is a partly sectional perspective view of a trailer upon in which a plurality of reinforcement devices according to FIG. 1 are supported.

FIG. 3 is a perspective view of the device prior to attachment to mounting apertures in the sidewall of the trailer.

FIG. 4 is a sectional side elevational side elevational view of the device mounted on the sidewall of the trailer.

FIG. 5 is top plan view of the device mounted on the side wall of the trailer.

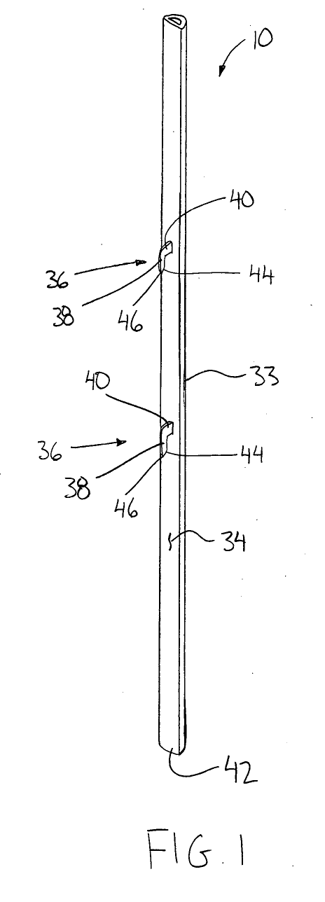

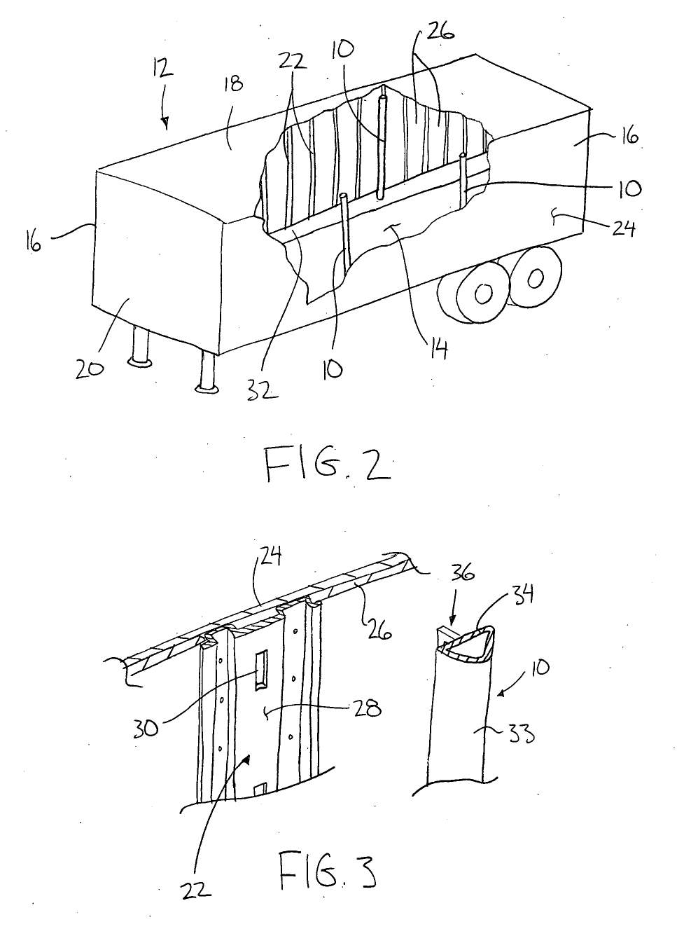

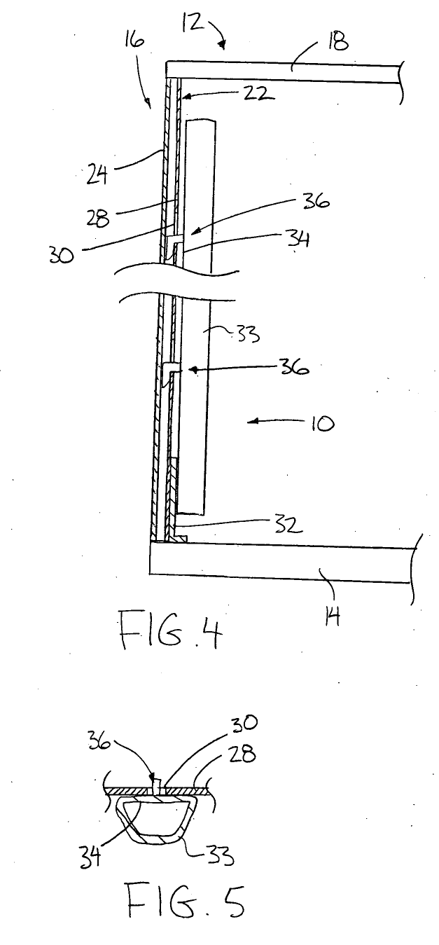

In the drawings like characters of reference indicate corresponding parts in the different figures.

### DETAILED DESCRIPTION

Referring to the accompanying figures there is illustrated a reinforcement device generally indicated by reference numeral 10. The device 10 is particularly suited for reinforcing the structure of a conventional enclosed trailer 12 for carrying cargo by road transport.

The trailer 12 typically includes a floor supported for rolling movement along the ground. Sidewalls 16 extend upwardly from opposing side edges of the longitudinal sides of the floor 14 to a roof 18 which spans across the opposing sidewalls 16 spaced above the floor. A front wall 20 enclosed the front end and a conventional door encloses the rear end of the trailer.

The sidewalls 16 are each formed of a plurality of mounting posts 22 which are vertically oriented and spaced apart from one another in the longitudinal direction of the trailer. An outer skin 24 spans the exterior of the posts to enclose the trailer, while interior panels 26 span the interior of the side walls between each adjacent pair of posts 22.

Each post includes an inner surface 28 which is spaced inwardly from the outer skin 24 to define a gap therebetween. Mounting apertures 30 are provided in the inner surface 28 at vertically spaced positions in the longitudinal direction of each post. The inner surface 28 is substantially flush with the interior panels 26. A base plate 32 overlaps the posts and the interior panels 26 adjacent the floor. The base plate 32 has a height in the order if eight to ten inches and is secured to the floor for added structural support to the sidewalls.

The reinforcement device 10 generally comprises a rigid post of high strength material which resists bending. The post is hollow, having a tubular cross section including a flat interior side 34 extending the full length of the device in the longitudinal direction. The rigid post is elongate, having a length which is near but slightly less than the interior height of the sidewalls of the trailer. Accordingly the rigid posts can be slidably displaced up and down between the floor and roof of the trailer when oriented vertically alongside the sidewalls.

The device further includes a pair of hook members 36 mounted on the rigid post 33 to project from the interior side 34 thereof. The hooks are longitudinally spaced and project in a common longitudinal direction in a common vertical plane with the longitudinal direction of the post 33. Each hook generally comprises a flat bar having a hook portion 38 supported alongside the post spaced outwardly therefrom by a corresponding spacer portion 40.

The hook portion is oriented parallel to the post and projects downwardly from the spacer portion towards the bottom end 42 of the post. The hook portion terminated at a camming face 44 located at the free end 46 thereof. The camming face 44 is a sloped surface angled upwardly and inwardly towards the post from the free end along an inner side of the hook portion for assisting in guiding the hook portion into the mounting apertures 30 in the mounting post. The length of the hook portion 38 is substantially equal or slightly less than the length of the mounting apertures 30 in the longitudinal direction thereof in a conventional trailer. The length of the spacer portion 40 which determines the width of the gap between the hook portion and the flat interior side 34 of the post is approximately equal to the thickness of the material forming the inner surface 28 of the mounting posts of the trailer and the base plate 24 together.

The spacing between the hook members 36 corresponds to a spacing between a selected pair of mounting apertures in a conventional trailer. Thus when it is desirable to carry loose loads which may exert a laterally outward force on the side walls which typically causes bending of the sidewalls, the reinforcement devices 10 are mounted at longitudinally spaced positions along the sidewalls at both sides of the trailer.

The devices are mounted in place by aligning the hook members 36 with a corresponding pair of the mounting apertures 30 with the bottom end 42 of the post being space upwardly from the floor and the rigid post 33 being parallel and alongside the mounting post upon which it is to be carried. The hook portion 38 of each hook member is then inserted far enough into the mounting apertures 30 to be received within the gap between the inner surface 28 and the outer skin of the sidewalls. The rigid post 33 is then slidably displaced downwardly from an unlocked position in which the rigid posts are readily removed, to a locked positioned in which the rigid posts are held securely against the sidewalls. In the locked position the bottom end of the rigid posts 33 overlap the base plate 32 at the floor in the longitudinal/vertical direction so that outward pressure on the posts causes the bottom end to engage the base plate and adequately resists bending of the sidewalls.

In further embodiments the rigid post 33 may be formed in a variety of cross sectional shapes including I-beams and the like. The posts 33 may be formed by extrusion with the hook members 36 being subsequently welded thereon. In the illustrated embodiments the posts 33 are formed of high strength steel, however any material which provides suitable strength and resistance against bending including a variety of composite materials and the like may be used. A variety of different shaped hook members may also be provided as long as they are still readily mounted within the mounting apertures in the sidewalls while remaining releasable therefrom.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. In a trailer comprising a floor, side walls extending up from the floor and a roof spanning the side walls in which the side walls include mounting posts having mounting apertures at vertically spaced positions therein, a reinforcement device comprising:
a rigid post having a length which is near a height of the mounting posts;
and hook members supported on the rigid post for being received in respective ones of the mounting apertures to support the rigid post in an upright orientation alongside one of the side walls.

2. The device according to claim 1 wherein the rigid post extends alongside the mounting post which receives the hook members therein.

3. The device according to claim 1 wherein the hook members are longitudinally spaced from one another within a common plane.

4. The device according to claim 1 wherein the hook members each include a hook portion projecting from the rigid post in a common direction to a free end including a camming face thereon.

5. The device according to claim 1 wherein the hook members include a hook portion extending downwardly alongside the rigid post towards a bottom end of the post, wherein the hook members are spaced upwardly from the bottom end of the rigid post.

6. The device according to claim 5 wherein the hook members are spaced upwardly from the bottom end of the post by at least one foot.

7. The device according to claim 1 wherein the rigid post comprises a hollow member of tubular cross-section.

8. A trailer comprising:
a floor;
side walls extending up from the floor;
a roof spanning the side walls spaced upwardly from the floor;
mounting posts having mounting apertures at vertically spaced positions along the wall;
a plurality of reinforcement devices, each comprising:
a rigid post having a length which is near a height of the mounting posts; and
hook members supported on the rigid post and selectively received in respective ones of the mounting apertures such that each rigid post is supported by the hook members in an upright orientation alongside one of the side walls.

9. The trailer according to claim 8 wherein the rigid post extends alongside the mounting post which receives the hook members therein.

10. The trailer according to claim 8 wherein the hook members are longitudinally spaced from one another within a common plane.

11. The trailer according to claim 8 wherein the hook members each include a hook portion projecting from the rigid post in a common direction to a free end including a camming face thereon.

12. The trailer according to claim 8 wherein the hook members include a hook portion extending downwardly alongside the rigid post towards a bottom end of the post, wherein the hook members are spaced upwardly from the bottom end of the rigid post.

13. The trailer according to claim 12 wherein the hook members are spaced upwardly from the bottom end of the post by at least one foot.

14. The trailer according to claim 8 wherein the rigid post comprises a hollow member of tubular cross-section.

15. A method of reinforcing a trailer comprising a floor, side walls extending up from the floor and a roof spanning the side walls in which the side walls include mounting posts having mounting apertures at vertically spaced positions therein, the method comprising:
providing a plurality of reinforcement devices, each comprising a rigid post having a length which is near a height of the mounting posts; and hook members supported on the rigid post; and
inserting the hook members of the reinforcement devices into respective ones of the mounting apertures of the mounting posts to support the rigid posts in an upright orientation alongside the side walls respectively.

16. The method according to claim 15 including sliding the reinforcement devices downward after inserting the hook members into the respective mounting apertures to displace the hook members from an unlocked position to a locked position.

17. The method according to claim 15 wherein the hook members include a hook portion extending downwardly alongside the rigid post towards a bottom end of the post, wherein the hook members are spaced upwardly from the bottom end of the rigid post.

18. The method according to claim 15 for a trailer including base plates spanning a bottom end of the side walls respectively, the method including overlapping the reinforcement devices over the base plates when inserting the hook members into the respective mounting apertures.

19. The method according to claim 15 wherein the hook members each include a hook potion projecting from the rigid post in a common direction to a free end including a camming face thereon.

20. The method according to claim 1 wherein the rigid post comprises a hollow member of tubular cross-section which resists bending.
